(19) United States
(12) Patent Application Publication
(10) Pub. No.: US 2016/0260991 A1
(43) Pub. Date: Sep. 8, 2016

(54) POWER GENERATION SYSTEM UTILIZING A FUEL CELL INTEGRATED WITH A COMBUSTION ENGINE

(71) Applicant: GENERAL ELECTRIC COMPANY, Schenectady, NY (US)

(72) Inventors: Andrew Philip Shapiro, Schenectady, NY (US); Matthew Joseph Alinger, Delmar, NY (US); Matthew Alexander Lehar, Munich (DE); Bruce Philip Biederman, West Hartford, CT (US)

(21) Appl. No.: 15/062,753

(22) Filed: Mar. 7, 2016

Related U.S. Application Data
(63) Continuation-in-part of application No. 13/077,066, filed on Mar. 31, 2011, now abandoned.
Application No. 13/077,066 is a division of application No. 13/722,370, filed on Dec. 20, 2012.

(51) Int. Cl. H01M 8/0612; H01M 8/04014; H01M 8/1213; H01M 8/1231; F02B 63/04; H01M 8/04089

(52) U.S. Cl. CPC H01M 8/0618; F02B 63/04; H01M 8/04097; H01M 8/1213; H01M 8/1231; H01M 8/04014; H01M 2008/1293

(57) ABSTRACT

A power generation system utilizing a fuel cell is described. The system includes a fuel cell having an anode configured to generate a tail gas. The anode includes an inlet and an outlet. The system further includes a fuel path configured to divert a first portion of the anode tail gas to the inlet of the anode; and a second portion of the anode tail gas to a reciprocating engine. The associated reciprocating engine is at least partially powered by the second portion of the anode tail-gas. Another embodiment of the invention is directed to a power generation system that includes the anode and an external fuel reforming system, along with a gas splitting mechanism to divide the reformed fuel into two streams. One stream is directed back to the fuel cell anode, while another stream is used to completely or partially power an external or internal combustion engine.

### CROSS REFERENCE TO RELATED APPLICATIONS

This Application is a Divisional Application of U.S. application Ser. No. 13/722,370, filed on Dec. 20, 2012; which is a Continuation-in-Part of U.S. application Ser. No. 13/077,066, filed on Mar. 31, 2011. Both of these documents are incorporated in their entirety, by reference.

### BACKGROUND

This invention is generally directed to power generation systems, and more particularly to combustion engine-fuel cell systems that include recirculation cycles which can improve the overall efficiency of power generation.

Fuel cells are electrochemical energy conversion devices that have demonstrated a potential for relatively high efficiency and low pollution in power generation. A fuel cell generally provides a direct current (dc) which may be converted to alternating current (ac) via, for example, an inverter. The dc or ac voltage can be used to power motors, lights, and any number of electrical devices and systems. Fuel cells may operate in stationary, semi-stationary, or portable applications.

Certain fuel cells, such as solid oxide fuel cells (SOFCs), may operate in large-scale power systems that provide electricity to satisfy industrial and municipal needs. Others may be useful for smaller portable applications such as for example, powering cars. Common types of fuel cells include phosphoric acid (PAFC), molten carbonate (MCFC), proton exchange membrane (PEMFC), and solid oxide (SOFC), all generally named after their electrolytes.

In practice, fuel cells are typically amassed in electrical series, in an assembly of fuel cells to produce power at useful voltages or currents. Therefore, interconnect structures may be used to connect or couple adjacent fuel cells in series or parallel. In general, components of a fuel cell include the electrolyte and two electrodes. The reactions that produce electricity generally take place at the electrodes where a catalyst is typically disposed to speed the reactions. The electrodes may be constructed as channels, porous layers, and the like, to increase the surface area for the chemical reactions to occur. The electrolyte carries electrically charged particles from one electrode to the other and is otherwise substantially impermeable to both fuel and oxidant.

The opportunity for a power generation system that can benefit greatly from the integration of a fuel cell and a combustion apparatus derives in large part from the electrochemistry of the fuel cell. Typically, the fuel cell converts hydrogen (fuel) and oxygen (oxidant) into water (byproduct) to produce electricity. The byproduct water may exit the fuel cell as steam in high-temperature operations.

The discharged steam (and other hot exhaust components) from the fuel cell may be utilized in turbines and other applications to generate additional electricity or power, providing increased efficiency of power generation. If air is employed as the oxidant, the nitrogen in the air is substantially inert and typically passes through the fuel cell. Hydrogen fuel may be provided via local reforming (e.g., on-site steam reforming) of carbon-based feedstocks, such as reforming of the more readily available natural gas and other hydrocarbon fuels and feedstocks. Examples of hydrocarbon fuels include natural gas, methane, ethane, propane, methanol, syngas, and other hydrocarbons.

The reforming of hydrocarbon fuel to produce hydrogen to feed the electrochemical reaction may be incorporated into the operation of the fuel cell. Moreover, such reforming may occur internal and/or external to the fuel cell. For reforming of hydrocarbons performed external to the fuel cell, the associated external reformer may be positioned remote from or adjacent to the fuel cell.

Fuel cell systems that can reform hydrocarbon internal and/or adjacent to the fuel cell may offer advantages, as described below. For example, the steam reforming reaction of hydrocarbons is typically endothermic, and therefore, internal reforming within the fuel cell or external reforming in an adjacent reformer may utilize the heat generated by the typically exothermic electrochemical reactions of the fuel cell. Furthermore, catalysts active in the electrochemical reaction of hydrogen and oxygen within the fuel cell to produce electricity may also facilitate internal reforming of hydrocarbon fuels. In SOFCs, for example, if a nickel catalyst is disposed at an electrode (e.g., an anode) to sustain the electrochemical reaction, the active nickel catalyst may also reform hydrocarbon fuel into hydrogen and carbon monoxide (CO). Moreover, both hydrogen and CO may be produced when reforming hydrocarbon feedstock. Thus, fuel cells, such as SOFCs that can utilize CO as fuel (in addition to hydrogen) are generally more attractive candidates for utilizing reformed hydrocarbon, and for internal and/or adjacent reforming of hydrocarbon fuel.

As described previously, the exhaust components from fuel cells that operate at high temperatures can be directed to turbines and other types of engines, as part of a general combined cycle system. While such a system can be an attractive method for power generation, there are still some drawbacks present, that can prevent wide-scale implementation. For example, the relatively low conversion efficiency of the fuel cell component can still diminish the value of the system. Some of the present day examples of fuel cells routinely achieve a conversion efficiency that is only about 50%.

It should thus be apparent that combined-cycle, power generation systems that incorporate fuel cells in a way that provides greater efficiency would be welcome in the art.

### BRIEF DESCRIPTION

One embodiment of the invention is directed to a power generation system utilizing a fuel cell, comprising

a) a fuel cell that includes an anode configured to generate a tail gas, wherein the anode comprises an inlet and an outlet;

b) a fuel path configured to divert a first portion of the anode tail gas to the inlet of the anode; and a second portion of the anode tail gas to a reciprocating engine; and

c) a reciprocating engine that is at least partially powered by the second portion of the anode tail gas.

Another embodiment of the invention is directed to a power generation system, comprising:

a solid-oxide fuel cell that includes an anode configured to generate a tail gas, the anode comprising an inlet and an outlet;

at least one external fuel reforming system, configured to mix a hydrocarbon fuel with the fuel cell tail gas downstream of the fuel cell, and to partly or fully convert the hydrocarbon fuel into a reformed fuel mixture comprising hydrogen (H₂) and carbon monoxide (CO);

a gas splitting mechanism configured to divide the reformed fuel mixture into two streams, each with substantially the same composition;

means for directing one of the reformed fuel mixture streams back to the inlet of the anode; and

an external or internal combustion engine that is capable of at least partly being powered by the other reformed fuel mixture stream.

### DRAWINGS

The foregoing and other features, aspects and advantages of the invention are apparent from the following detailed description taken in conjunction with the accompanying drawings in which like characters represent like parts throughout the drawings, wherein:

FIG. 1 is a diagram of one embodiment of a power generation system that employs a fuel cell, according to this invention.

FIG. 2 is a diagram illustrating a power generation system, according to another embodiment.

FIG. 3 is a depiction of a power generation system according to other inventive embodiments.

FIG. 4 is a depiction of yet another embodiment for the power generation system.

FIG. 5 provides a description of an additional embodiment of the power generation system.

FIG. 6 is a diagram for another embodiment of the power generation system.

### DETAILED DESCRIPTION

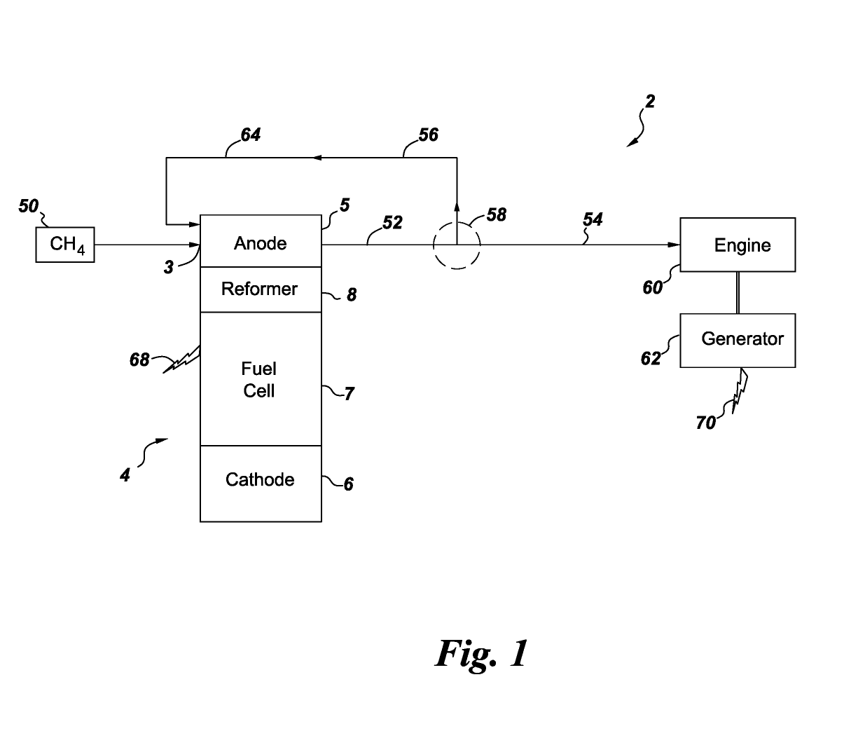

FIG. 1 is a simplified diagram of a power generation system 2 that utilizes a fuel cell 4. The fuel cell comprises anode 5, cathode 6, and electrolyte 7, and is often supplied with hydrocarbon fuel, e.g., methane. Those skilled in the art understand the general structure and function of fuel cells. As described elsewhere herein, fuel cell 4 is often an SOFC device. There are numerous advantages associated with the use of an SOFC device in this type of combined cycle system.

In some embodiments, fuel cell 4 includes an internal reformer. The reformer is depicted simply as feature 8 in FIG. 1, which is meant to represent the reforming action of these types of fuel cells. As mentioned previously, such a reformer can function by utilizing the heat generated by the exothermic, electrochemical reactions of the fuel cell. Furthermore, the fuel cell system can in some cases include catalysts that also facilitate internal reforming, as described previously. The use of an internal reformer may be advantageous in some situations, in terms of simplicity in design and operation, and in view of some of the thermodynamic considerations mentioned above. (Those considerations can be especially important for the environment in which a solid oxide fuel cell operates).

With continued reference to FIG. 1, fuel 50 is usually directed into an inlet 3 of the anode 5 of the fuel cell, by any conventional routing mechanism. Oxygen (or any suitable oxidant) is also directed into the fuel cell by any conventional technique, and need not be specifically depicted in the figure. Although methane (CH₄) is depicted as the illustrated fuel, many other types of hydrogen-containing substances (e.g., hydrocarbon fuels) can be used, as discussed elsewhere.

The reforming action of the fuel cell partially or fully converts the fuel into a mixture comprising hydrogen (H₂) and carbon monoxide (CO). These gases exit the anode of the fuel cell through any suitable pathway 52, and constitute at least a portion of the anode exhaust, often referred to as the anode “tail gas”. Those skilled in the art understand that electricity is also produced in the fuel cell reaction, and routed out of the fuel cell through an appropriate electrical circuit (not specifically shown here). Water is another byproduct, in steam- or liquid form. Thus, the anode exhaust may also include various other components in addition to hydrogen and carbon monoxide, such as water, steam, and carbon dioxide. While various factors might affect its composition, the anode exhaust is usually comprised of at least about 10% by volume of carbon monoxide and hydrogen, and in some embodiments, at least about 20% of carbon monoxide and hydrogen, e.g., up to about 40%.

As shown in FIG. 1, the anode exhaust or tail gas being directed through pathway 52 is split into a first portion 54 and a second portion 56, at junction 58. (There is no restriction on the type of junction used, and the illustration is meant to cover any type of standard, mechanical splitting mechanism, e.g., a valve or piping mechanism). In most embodiments, each portion 54, 56 has substantially the same composition. Moreover, in some preferred embodiments of this invention, the features of the power generation system that deal with the movement and/or division of gases and mixed-gas streams are free of membranes or membrane structures. The absence of the membranes and membrane structures can be a distinct advantage—especially for larger-scale industrial systems.

In most embodiments, first portion 54 is directed to a reciprocating engine 60, sometimes referred to as a “gas reciprocating engine” or a piston engine. Various types of reciprocating engines can be used, and most fall into three main categories: internal combustion engines, steam engines, and Stirling engines. Some non-limiting, specific examples include reciprocating 4-stroke engines, reciprocating 2-stroke engines, and opposed piston 2-stroke engines. (Power generation regions which rely in part on excess heat from an overall system are sometimes referred to as “bottoming cycles”, as mentioned below for other embodiments).

In some particular embodiments, internal combustion engines like the Jenbacher and Waukesha types are preferred. In addition to being supplied by anode exhaust portion 54, these types of engines can very efficiently operate on a variety of other, optional fuels, in addition to the traditional hydrocarbons like methane. Other fuel types include landfill gas, coal gas, bio-derived fuels, and the like. (The intake mechanism for the additional fuel is conventional, and not specifically depicted in FIG. 1).

Reciprocating engine 60 may be employed in a number of functions. The engine may be used to perform conventional, mechanical work, e.g., by way of conventional mechanical motion. Alternatively (or in addition to that function), the engine may specifically serve to power generator 62, as depicted in FIG. 1. In some cases (e.g., in the case of Jenbacher and Waukesha machines), engine 60 and generator 62 may be in the form of a combined engine-generator set. In some preferred embodiments, reciprocating engine 60 is powered solely by the fuel stream that makes up fuel portion 54.

With continued reference to FIG. 1, the second portion 56 of the anode exhaust/tail gas that is split at junction 58 is recirculated to the anode 5 of the fuel cell, by way of return path 64. Usually, the second portion is recirculated to inlet location 3, thereby providing additional fuel for the fuel cell. This inlet may be the same entryway or a different entryway as that used for fuel 50.

As mentioned previously, the anode exhaust contains hydrogen and carbon monoxide. Recirculation of the hydrogen component to fuel cell 4 can enhance its efficiency considerably. Thus, the recirculation of the anode exhaust represents a second cycle in the power generation, i.e., in addition to the engine-based cycle fed by first anode exhaust portion 54.

Moreover, in most preferred embodiments, at least about 50 volume % of the total anode exhaust is recirculated to the anode, with most of all of the remainder (first portion 54) being directed to the reciprocating engine. In some preferred embodiments, at least about 75 volume % of the total anode exhaust is recirculated to the anode, and in some instances, the level is greater than about 85 volume %.

For the embodiment of FIG. 1, as well as other embodiments, two sources of electrical generation are present. As alluded to previously, the fuel cell itself is the first electrical production device, delivering electrical current 68 to a desired location, e.g., an external circuit. The second electrical production device is the electrical generator (when present), described previously, e.g., device 62, that also provides electrical current 70 to a desired location. The ability for the overall system 2 to provide two sources of electrical power, with a “boost” originating by way of the recirculation cycle that feeds the fuel cell, is a distinct advantage in various industrial operations.

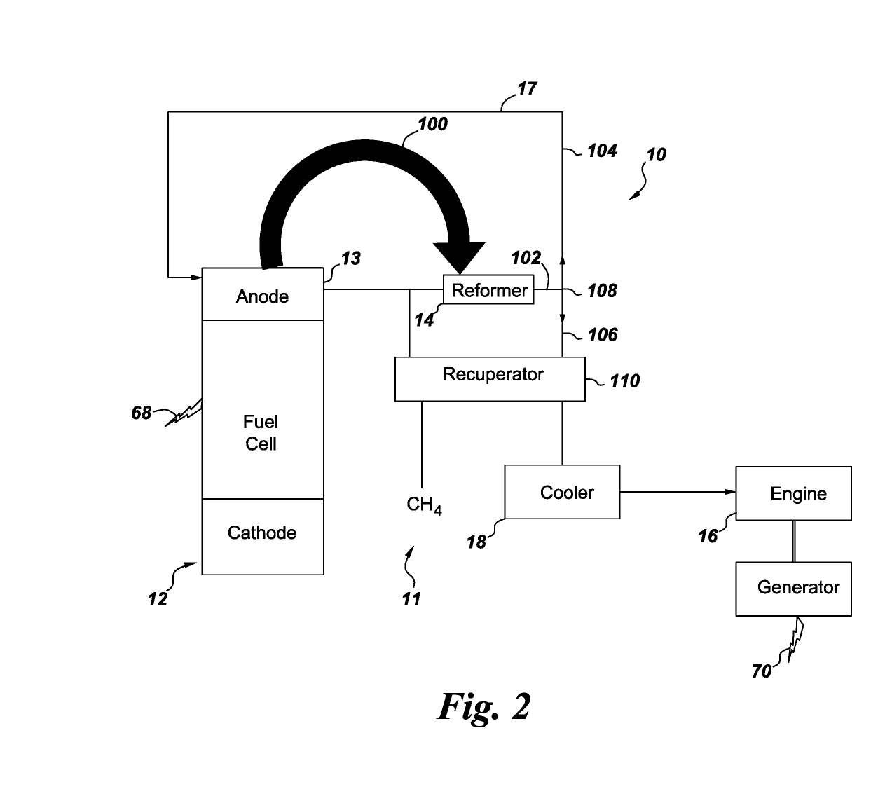

FIG. 2 represents another embodiment of the invention. The figure is a simplified diagram illustrating a combined cycle power plant 10 that employs a fuel cell, e.g., an SOFC 12, running on reformed fuel. The system includes a recirculation mechanism, in which a reformer 14 (usually an external reformer, in contrast to the embodiment of FIG. 1) feeds a reciprocating engine bottoming cycle according to one embodiment. A hydrocarbon fuel 11 such as CH₄, is admitted to the system 10, downstream of the fuel cell anode 13, via any suitable conduit 15, as depicted in FIG. 2. The fuel 11 is partly or fully converted into H₂ and CO within the reformer 14, according to the reforming reaction mentioned previously. The reaction can also be promoted by some portion of the heat given off by the fuel cell 12, as generally illustrated with arrow 100.

In this embodiment, the reformed fuel stream moving along pathway 102 is split into a first portion 104 and a second portion 106, at junction 108. Thus, a fraction 104 of the reformed fuel stream is diverted to the inlet of the fuel cell anode 13 via any suitable means, e.g., a return path/conduit 17. The combination of incoming fuel with at least a portion of the anode exhaust gas is an important feature for some embodiments. It contrasts with some systems in the art, wherein incoming fuel was combined only with water or steam present in a fuel cell/power plant system. The combination of fuel with the anode gas occurring prior to external reforming (and thus, prior to that exhaust gas splitting) represents another important feature for some embodiments.

The residual fraction of the reformed fuel stream is employed to drive an external or internal combustion engine 16. As described previously, engine 16 may comprise, for example, a reciprocating 4-stroke, reciprocating 2-stroke, or an opposed piston 2-stroke engine. The engine may also be any type of gas turbine.

In some (though not all) preferred embodiments, a recuperator 110, or another type of heat exchanger, is used to transfer heat that originates in the fuel cell, to the incoming fuel stream 11 (sometimes referred to herein as “fresh fuel”), prior to entry of the anode exhaust and the fuel 11 into reformer 14. Additionally, any type of suitable cooler 18 can be used to bring down the temperature of the reformed fuel (second portion 106 in FIG. 2), prior to directing the second portion into combustion engine 16.

Thus, it should be emphasized that in some preferred embodiments for this type of configuration, using an external reformer, “fresh fuel”, as mentioned below, is added to the system, after the fuel cell stage, and before the reforming stage. After reforming, the recirculated gas (now containing both the anode exhaust and the reformed fuel) may contain at least about 35% by volume of hydrogen and carbon monoxide, e.g., about 40-45%. At least a portion of this gaseous mixture is recirculated back to the anode inlet.

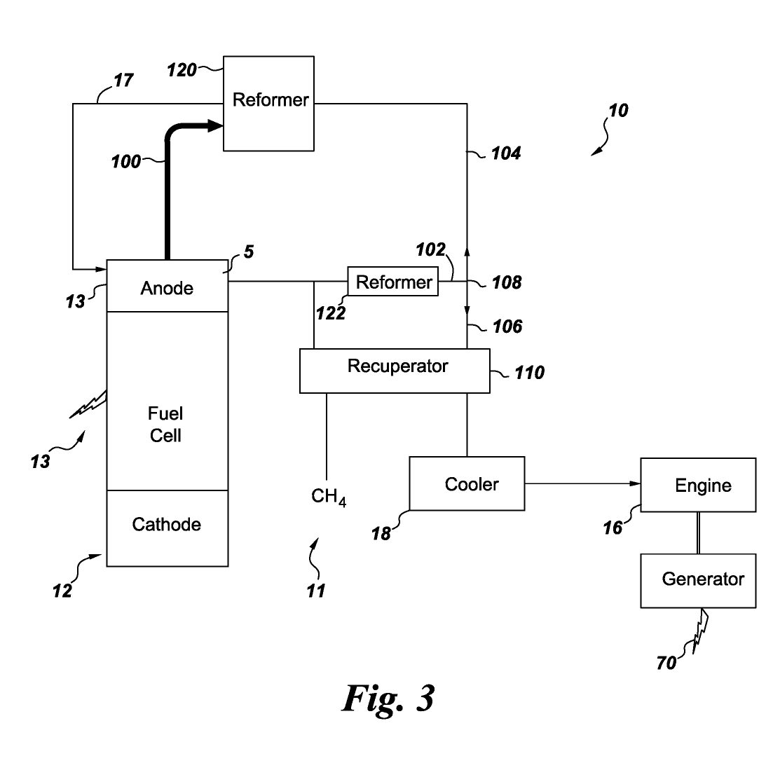

FIG. 3 is a depiction for another embodiment, which is also based on a combined cycle system that includes fuel cell 13, e.g., an SOFC; and a combustion engine 16, which can also be in the form of a gas turbine, or the like. As in the previous embodiment (FIG. 2), the system includes a recirculation system. Moreover, a suitable fuel (e.g., a hydrocarbon like methane) is directed into the system, downstream of the fuel cell anode 13.

In this embodiment, two reformers 120 and 122 are employed, as shown in the figure. The heat from the cathode 6 of the fuel cell is directed through a suitable conduit to reformer 120 (see the heat arrow generally depicted as element 100), and can assist in promoting a reforming reaction. Another portion of the anode exhaust is directed to reformer 122, which also promotes the reforming reaction. As compared to the single-reformer embodiment of FIG. 2, this gas stream has a lower heat content, i.e., (it is a cooler gas stream), which can be very advantageous in some circumstances.

As in the previous embodiment, the reformed stream exiting reformer 122 is split into a first portion 104 and a second portion 106, at splitting junction 108. Portion 106 can be used to, completely or partially, power engine 16, as in the previous embodiment. Moreover, the system may optionally include recuperator 110 and cooler 18. It should also be noted that in some embodiments, reformers 120 and 122 can effectively be combined.

In this embodiment, the first portion 104 of the reformed stream is directed back to reformer 120, as shown in FIG. 3. Thus, additional reforming can take place, aided by the heat component 100. The reformed fuel is then directed back to the anode, via pathway 17.

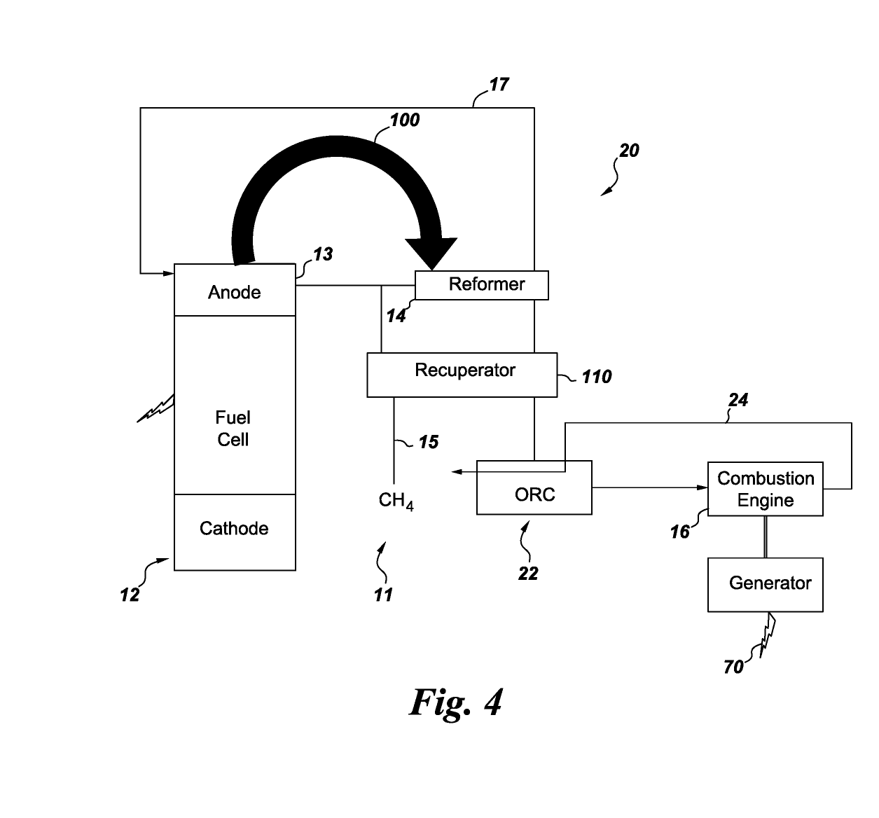

FIG. 4 is a simplified diagram illustrating another combined cycle power plant 20 that employs a fuel cell (e.g., an SOFC) 12 running on reformed fuel, with recirculation, in which a reformer 14 feeds a reciprocating engine bottoming cycle, according to another embodiment. A hydrocarbon fuel 11 such as CH₄ is admitted to the system 20, downstream of the fuel cell anode 13, at location 15, depicted in FIG. 4. The fuel 11 is partly or fully converted into H₂ and CO within the reformer 14, optionally using some portion of the heat given off by the fuel cell 12, to promote the reforming reaction. Some fraction of the reformed fuel stream is diverted to the inlet of the fuel cell anode 13, via a return path 17, and the residual fraction of the reformed fuel stream is cooled through one or more heat removal steps. For example, heat removal can occur during the process of warming the fuel stream 11 by means of a recuperator (as generally described for other embodiments), and then as the reformed fuel stream passes through an organic Rankine cycle (ORC) 22. The cooled fuel stream is then employed to drive an external or internal combustion engine 16, e.g., any of the types described above.

With continued reference to FIG. 4, the ORC system 22 advantageously may be employed to generate additional electrical power. According to another embodiment, heat from the combustion engine 16 exhaust may be transferred to the working fluid of the ORC 22 via a return path 24. In this manner, the production of electrical power provided by the ORC 22 is further increased.

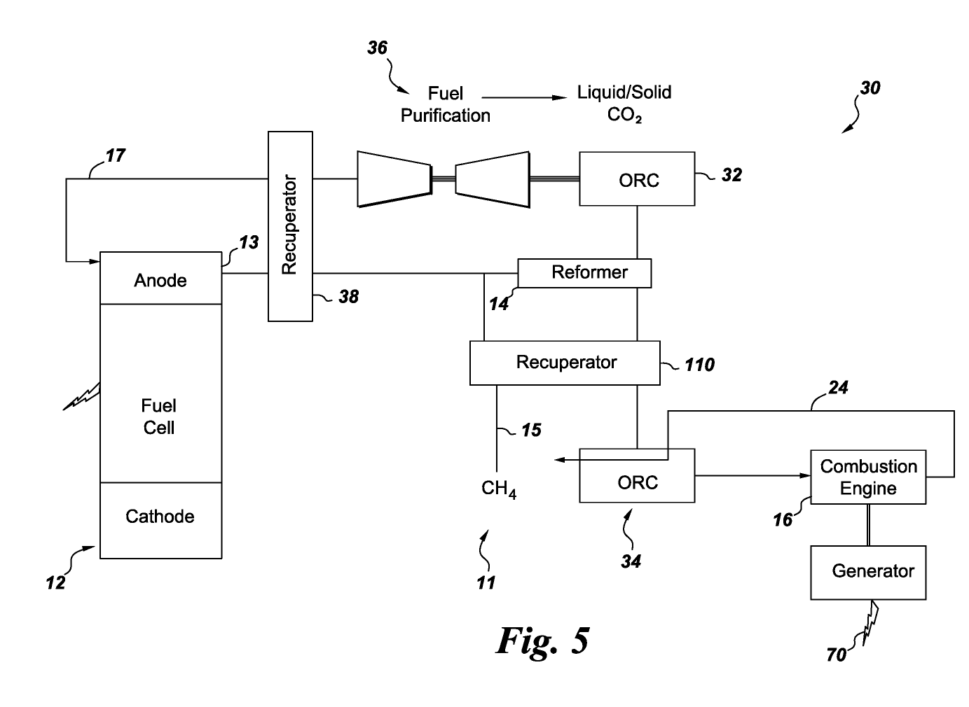

FIG. 5 is a simplified diagram for another embodiment of the invention, again involving a combined cycle power plant (30) that employs a fuel cell 12 (e.g., SOFC), running on reformed fuel, with a recirculation mechanism. The recirculation system includes a reformer 14 that feeds a reciprocating engine bottoming cycle, according to yet another embodiment. A hydrocarbon fuel 11, such as CH₄ is admitted to the system 30, downstream of the fuel cell anode 13, at location 15, depicted in FIG. 5. The fuel 11 is partly or fully converted into H₂ and CO within the reformer 14, optionally using some portion of the heat given off by the fuel cell 12, to promote the reforming reaction. Some fraction of the reformed fuel stream is diverted to the inlet of the fuel cell anode 13, via a return path 17.

With continued reference to FIG. 5, it can be seen that the recirculated fraction is first cooled, via an ORC 22, prior to diverting/recirculating the fraction of the reformed fuel stream to the inlet of the fuel cell anode 13. The ORC feature can be followed by fuel purification apparatus (generally depicted at 36) that may comprise, without limitation, compression, heat rejection and expansion processes. The resulting cooling will cause the products of combustion, including H₂O and CO₂, to condense out of the resultant stream of fuel. The solid or liquid CO₂ may then be stored or pumped to high pressures in liquid form, for eventual sequestration. This process is substantially driven by power derived in the ORC 34, from the heat of the recirculated 17 stream of fuel. The residual fraction of the reformed fuel stream may optionally be cooled through heat removal, as it passes through an Organic Rankine cycle (ORC) 34 (FIG. 5). This cooled fuel stream is then employed to drive an external or internal combustion engine 16, as described previously.

According to one embodiment related to FIG. 5, the ORC 34 advantageously may be employed to generate additional electrical power. According to another embodiment, heat from the combustion engine 16 exhaust may be transferred to the working fluid of the ORC 34 via a return path 24, to further boost the production of electrical power provided by the ORC 34. According to another embodiment, a single ORC is employed to provide both recirculated and residual fuel streams.

The combined cycle power plant 30 further employs a recuperator 38 in many of these embodiments, as shown in FIG. 5. It should be emphasized that reforming of the hydrocarbon primary fuel occurs upstream of the fuel cell in conventional combined cycle fuel cell systems. In those situations, tail gas from the fuel cell, including unburnt fuel and products of combustion, are then often sent to tail-gas burners, the heat from which can be incorporated in the combined cycle system, sometimes into a fuel reformer.

In contrast, for some of the embodiments of this invention (e.g., see FIG. 5), the primary fuel 11 used in combined cycle power plant 30 is combined with the anode tail-gas and sent to the reformer 14, downstream of the fuel cell 12. The endothermic reforming reaction is supplied heat from the anode tail-gas, directly and/or through a heat exchanger (recuperator) 38, and/or through a direct exchange of heat between the anode 13 and the reformer 14.

The combined cycle power plant 30 (e.g., FIG. 5) advantageously increases the fuel quality beyond that achievable, using a convention combined cycle fuel cell system. This is partially due to the fact that the quality of the fuel stream exiting the reformer 14 is substantially greater than the tail-gas leaving the fuel cell 13, in part because it is fully reformed. The fuel sent to a combustor for a bottoming cycle engine, such as combustion engine 24, is thus fully reformed. Thus, waste heat from the fuel cell 13 can be used as efficiently as possible. Further, the combined cycle power plant bottoming cycle advantageously requires less air flow for fuel cell cooling purposes, due to full reforming of the fuel.

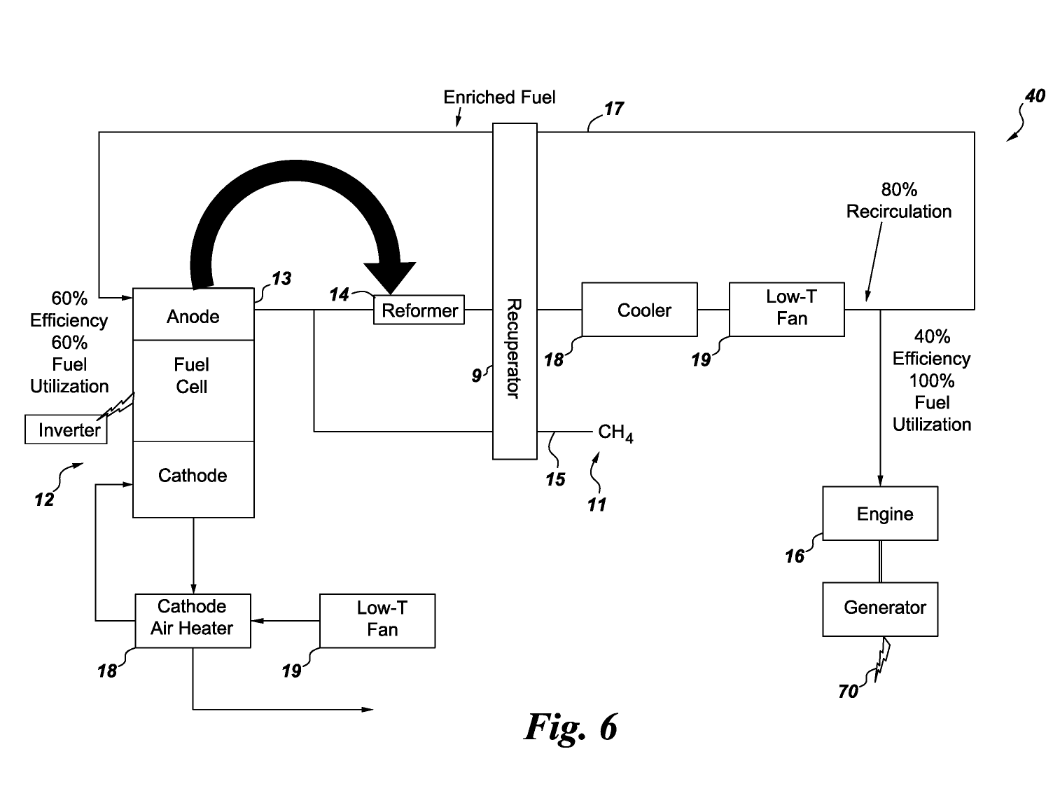

FIG. 6 is directed to another embodiment of the invention, again embracing a combined cycle power plant (40) that employs a fuel cell, such as SOFC 12. The fuel cell runs on reformed fuel, with the recirculation mechanism, in which a reformer 14 feeds a reciprocating engine bottoming cycle. A hydrocarbon fuel 11, such as CH₄, is admitted to the system 40 downstream of the fuel cell anode 13, at location 15, as depicted in the figure. The fuel 11 is partly or fully converted into H₂ and CO within the reformer 14, optionally using some portion of the heat given off by the fuel cell 12, to promote the reforming reaction.

Some fraction of the reformed fuel stream is diverted to the inlet of the fuel cell anode 13, via a return path 17. The residual fraction of the reformed fuel stream is employed to drive an external or internal combustion engine, as described above, subsequent to cooling. The cooling step can be carried out by way of the transfer of heat within a high temperature recuperator 9 to the incoming fuel stream 11, and then by means of a suitable cooler 18, and a low temperature fan 19.

With continued referenced to FIG. 6, it can be appreciated that the use of low temperature fan 19 is advantageously less expensive than employing a high temperature fan that is more costly to employ. Low temperature fan 19 functions to ensure that the recirculated flow of the reformed fuel stream occurs in a counter-clockwise motion, as depicted in the figure. The high temperature recuperator 9 operates to remove heat from the flow going into the low-temperature fan 19. This heat is then transferred into the flow coming out of the low-temperature fan 19. These features advantageously allow recirculation of a high-temperature fuel stream back to the fuel cell 12, while imparting a motive force to the flow at low temperature. As can be seen in FIG. 6, the recuperator 9 is also employed to heat the incoming natural gas fuel stream 11.

For many of the embodiments described herein, an overall fuel utilization that is higher than 65% has been achieved, by recirculating flow from the anode exhaust back to the anode inlet. Furthermore, by including the reforming step in a recirculation loop, the reformer water requirements can be met using only the water contained in the anode exhaust flow, without having to introduce additional water to the overall system.

Moreover, the embodiments described herein, (i.e., those that use an external reformer), advantageously implement reforming downstream of the fuel cell anode 13. Because the reforming step occurs at a point between the fuel cell 12 exhaust and the bottoming cycle fuel inlet, some of the reformed fuel may be fed directly to the bottoming cycle. The reformer 14 (e.g., FIG. 2) draws more heat from the fuel cell 12, because it is reforming the fuel supplied to the bottoming cycle, as well as that of the fuel cell 12. According to one aspect, the reformer 14 may be able to use more of the excess heat of the fuel cell 12 to enrich the fuel than would be possible in present state-of-the-art combined cycle fuel cell systems, thus increasing overall system efficiency.

Moreover, as mentioned previously, some of the embodiments described herein advantageously employ a reciprocating gas engine as a bottoming cycle. Since reciprocating gas engines are traditionally more fuel-flexible than gas turbines, for example, they allow for more flexibility in the design of the reformer 14 than would be possible if a gas turbine were to be used as the bottoming cycle.

As a general summary, it should be noted that combined cycle fuel cell embodiments and their attendant advantages have been described herein. These embodiments each comprise a fuel cell (e.g., an SOFC) comprising an anode that generates a tail gas. Some of the variations involve the use of internal reforming, while others rely on the presence of an external reformer. In regard to the latter, a hydrocarbon fuel reforming system mixes a hydrocarbon fuel with the fuel cell tail-gas downstream of the fuel cell unit, so as to partly or fully convert the hydrocarbon fuel into hydrogen (H₂) and carbon monoxide (CO). The reformed fuel is split into a first portion and a residual portion. A fuel path diverts the first portion of the reformed fuel to the inlet of the fuel cell anode. A cooling system such as a cooler or cooler/low-temperature fan combination is optionally configured to remove heat from the residual portion of the reformed fuel and to deliver the cooled residual portion of the reformed fuel to a bottoming cycle. The bottoming cycle can include a reciprocating gas engine that is driven in response to the cooled residual portion of the reformed fuel.

It should also be clear from this description that another embodiment of this invention is directed to a method for power generation, in which fuel is directed into a fuel cell to provide one source of electrical energy. The exhaust (reformed fuel) from the fuel cell is directed to any type of splitting device, for division into two portions. One portion of the exhaust is used to provide additional fuel for the fuel cell. Another portion of the exhaust is used to drive various types of engines or engine-generator sets, and can thereby provide another source of electrical energy.

The present invention has been described in terms of some specific embodiments. They are intended for illustration only, and should not be construed as being limiting in any way. Thus, it should be understood that modifications can be made thereto, which are within the scope of the invention and the appended claims. Furthermore, all of the patents, patent applications, articles, and texts which are mentioned above are incorporated herein by reference.

What is claimed:

1. A power generation system, comprising:
a solid-oxide fuel cell comprising an anode configured to generate a tail gas, the anode comprising an inlet and an outlet;
at least one external fuel reformer, configured to mix a hydrocarbon fuel with the fuel cell tail gas downstream of the fuel cell, and to partly or fully convert the hydrocarbon fuel into a reformed fuel mixture comprising hydrogen (H₂) and carbon monoxide (CO);
a gas splitting mechanism configured to divide the reformed fuel mixture into two streams, each with substantially the same composition;
means for directing one of the reformed fuel mixture streams back to the inlet of the anode; and
an external or internal combustion engine that is capable of at least partly being powered by the other reformed fuel mixture stream.

2. The power generation system of claim 1, wherein the engine is a reciprocating gas engine.

3. The power generation system of claim 1, comprising two electrical production devices.

4. The power generation system of claim 3, wherein the first electrical production device is the fuel cell electrical circuit; and the second electrical production device is an electrical generator powered by the external or internal combustion engine.

5. The power generation system of claim 1, comprising a second, external fuel reformer, situated at a location between the gas splitting mechanism and the inlet of the anode, and incorporated into the means for directing the reformed fuel mixture back to the anode.

6. The power generation system of claim 5, wherein the second reformer includes entry means for accepting heat directed thereto from the fuel cell.

7. The power generation system of claim 1, further comprising at least one cooler that is configured to remove heat from the reformed fuel mixture stream that is used to power the engine.

8. A combined cycle power generation system, according to claim 1.
